(19) United States
(12) Patent Application Publication
(10) Pub. No.: US 2014/0357378 A1
(43) Pub. Date: Dec. 4, 2014

(54) METHOD FOR PROVIDING ITEM COLLECTION EVENT AND SERVER

(71) Applicant: Intellectual Discovery Co., Ltd., Seoul (KR)

(72) Inventor: Hyun Cho Jung, Seoul (KR)

(73) Assignee: INTELLECTUAL DISCOVERY CO., LTD., Seoul (KR)

(21) Appl. No.: 14/363,964

(22) PCT Filed: Nov. 20, 2012
(86) PCT No.: PCT/KR2012/009806

§ 371 Date: Jun. 9, 2014

(30) Foreign Application Priority Data
Dec. 9, 2011 (KR) 10-2011-0132172

(51) Int. Cl. A63F 13/335

(52) U.S. Cl. CPC A63F 13/335
USPC 463/42

(57) ABSTRACT

A technique provides new fun through an item gain and obtains a new benefit according to the item gain. An item collection event providing method according to an exemplary embodiment of the present invention includes: transmitting an item collection screen including at least one slot for collection in which each collection of at least one item to be collected is displayed to a user terminal according to an item collection event as an event providing a reward according to a collection of the item when collecting at least one predetermined item; receiving a selection input for any one slot among at least one slot for the collection from the user terminal; transmitting a slot item usage menu as a menu to receive a usage input of a slot item as an item to be used in an arbitrary slot to the user terminal when receiving the selection input; and determining the item corresponding to any one slot selectively input by using the slot item to be collected when receiving the selection input for the slot item usage menu.

### TECHNICAL FIELD

The present invention relates to a method for providing an event constantly providing an item if items to be obtained in a game are connected by a game play and a server thereof, and in detail, relates to a technique for providing a server to assist in completing the collection of the item.

### BACKGROUND ART

Recently, as online network services have been developed with development of graphics techniques, a number of users using game contents has suddenly increased. The game contents are provided as various kinds to fulfill vicarious satisfaction by operating a character to deputize for the user in a virtual world, or by operating various objects existing in real life.

For example, the user generates a character in a fantasy world and increases a level of the character for a variety of actions, such that the user may reduce stress of reality in the virtual world and have fun.

Also, in a sports game, etc., by operating a character of a real football player, the user may be a director of the football game, the player, and a team owner, such that the user may fulfill vicarious satisfaction and accordingly may have fun.

In the game contents, for distinction from other users when playing the game and using the game through the users, various items to be used in the game contents are provided.

The items are provided as various kinds to help improve a capacity value of the game character on behalf of the users, obtain an experience value through the game character, and decorate an exterior of the character, and the item may be purchased and sold by using cyber-money that may be obtained according to game play, or may be serviced by actually paying cash to make the purchase.

On the other hand, a requirement for the service providing the new fun by using the item is increased away from the conventional gaming service using the items for only providing the fixed effect to the users.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention increase a utilization rate for an item collection service of users by assisting to collect items in a service setting a portion of the items to be obtained or purchased by the users as a collection object item and providing a predetermined reward when connecting the predetermined item. Also, the present invention makes money by using the item collection service through the users.

### Technical Solution

A method for providing an item collection event through an event providing server according to an exemplary embodiment of the present invention includes: transmitting an item collection screen including at least one slot for collection in which each collection of at least one item to be collected is displayed to a user terminal according to an item collection event as an event providing a reward according to a collection of the item when collecting at least one predetermined item; receiving a selection input for any one slot among at least one slot for the collection from the user terminal; transmitting a slot item usage menu as a menu to receive a usage input of a slot item as an item to be used in an arbitrary slot to the user terminal when receiving the selection input; and determining the item corresponding to any one slot selectively input by using the slot item to be collected when receiving the selection input for the slot item usage menu.

In the determining step, information informing that the usage of the slot item has failed may be transmitted when a number of slots using the slot item exceeds a predetermined threshold value among at least one slot for the collection included in the item collection screen.

In the transmitting of the item collection screen to the user terminal, the item collection screen in which the slot determined by the collected item through the item possession of the user, the slot determined by the non-collected item, and the slot determined by the collected item by using the slot item may be displayed to be different is transmitted to the user terminal.

The method may further include transmitting a collection reward menu as a menu input to provide at least one predetermined item according to the collection of the item at a portion of the item collection screen to the user terminal.

The method may further include providing at least one predetermined item to the database of the item possessed to the user when receiving the selection input from the user terminal for the collection reward menu.

In the providing of the item, different items may be provided depending on a ratio of a sum of the number of slots determined by the collected item through the possessed item of the user and the number of slots determined by the collected item by using the slot item for the number of all slots included in the item collection screen.

In the providing of the item, at least one predetermined item may be provided after deleting the item corresponding to the slot determined by the collected item from the database of the item possessed by the user when providing the item.

In the providing of the item, the item corresponding to the slot except for the slot determined by the collected item by using the slot item may be deleted among the slots determined by the collected item.

In the determining, when receiving the selection input for the slot item usage menu, when the slot item does not exist in the database of the item possessed by the user, the information informing that the usage of the slot item has failed may be transmitted to the user terminal.

A server for providing an item collection event according to an exemplary embodiment of the present invention includes: a slot selection input receiver transmitting an item collection screen including a slot for at least one collection and displaying each collection existence of at least one item to be collected and receiving a selection input from the user terminal for any one slot among the slots for at least one collection according to an item collection event as an event providing a reward according to the collection of the item when collecting at least one predetermined item; a slot item usage controller transmitting a slot item usage menu as a menu to receive usage input of a slot item as an item to be used in an arbitrary slot to the user terminal when receiving a selection input and determining the item corresponding to any one selectively input slot by using the slot item to be collected when receiving the selection input for the slot item usage menu; and a reward item providing unit transmitting a collection reward menu as a menu input to provide at least one predetermined item for input according to the collection of the item to the user terminal on a portion of the item collection screen and providing at least one predetermined item to a database of the item possessed by the user when receiving the selection input from the user terminal for the collection reward menu.

The slot item usage controller may transmit information informing that the usage of the slot item has failed when the number of slots using the slot item exceeds a predetermined threshold value among the slot for at least one collection included the item collection screen.

The reward item providing unit may provide the different items depending on a ratio of a sum of the number of slots determined by the collected item through the possession item of the user and the number of slots determined by the collected item by using the slot item for the number of all slots included in the item collection screen.

The reward item providing unit may provide at least one predetermined item after deleting the item corresponding to the slot determined by the collected item when providing the item from the database of the item possessed by the user.

The reward item providing unit may delete the item corresponding to the slot except for the slot determined by the collected item by using the slot item among the slot determined by the collected item.

### Advantageous Effects

According to the present invention, in the event of collecting the item, when it is difficult for the user to collect the item, the usage of the slot item is executed instead of the item collection such that the user may be provided with ease of usage of the item collection event, thereby increasing a participation rate of the user for the item collection event and a utilization rate thereof. Also, a benefit of the usage of the new item may be expected.

### DESCRIPTION OF THE DRAWINGS

FIG. 1 is a flowchart of a method for providing an item collection event according to an exemplary embodiment of the present invention.

FIG. 2 is a flowchart providing a reward item according to realization of an exemplary embodiment of the present invention.

FIG. 3 is a flowchart when providing a reward item according to realization of an exemplary embodiment of the present invention.

FIG. 4 is a flowchart of controlling usage of a slot item according to realization of an exemplary embodiment of the present invention.

FIG. 5 is a schematic diagram of a server for providing an item collection event according to an exemplary embodiment of the present invention.

FIGS. 6 to 13 show examples of an event screen displayed to a user terminal according to realization of an exemplary embodiment of the present invention.

### MODE FOR INVENTION

A method for providing an item collection event through an event providing server according to an exemplary embodiment of the present invention includes: transmitting an item collection screen including at least one slot for collection in which each collection of at least one item to be collected is displayed to a user terminal according to an item collection event as an event providing a reward according to a collection of the item when collecting at least one predetermined item; receiving a selection input for any one slot among at least one slot for the collection from the user terminal; transmitting a slot item usage menu as a menu to receive a usage input of a slot item as an item to be used in an arbitrary slot to the user terminal when receiving the selection input; and determining the item corresponding to any one slot selectively input by using the slot item to be collected when receiving the selection input for the slot item usage menu.

In the determining step, information informing that the usage of the slot item has failed may be transmitted when a number of slots using the slot item exceeds a predetermined threshold value among at least one slot for the collection included in the item collection screen.

In the transmitting of the item collection screen to the user terminal, the item collection screen in which the slot determined by the collected item through the item possession of the user, the slot determined by the non-collected item, and the slot determined by the collected item by using the slot item may be displayed to be different is transmitted to the user terminal.

The method may further include transmitting a collection reward menu as a menu input to provide at least one predetermined item according to the collection of the item at a portion of the item collection screen to the user terminal.

The method may further include providing at least one predetermined item to the database of the item possessed to the user when receiving the selection input from the user terminal for the collection reward menu.

In the providing of the item, different items may be provided depending on a ratio of a sum of the number of slots determined by the collected item through the possessed item of the user and the number of slots determined by the collected item by using the slot item for the number of all slots included in the item collection screen.

In the providing of the item, at least one predetermined item may be provided after deleting the item corresponding to the slot determined by the collected item from the database of the item possessed by the user when providing the item.

In the providing of the item, the item corresponding to the slot except for the slot determined by the collected item by using the slot item may be deleted among the slots determined by the collected item.

In the determining, when receiving the selection input for the slot item usage menu, that the slot item does not exist in the database of the item possessed by the user, the information informing that the usage of the slot item has failed may be transmitted to the user terminal.

A server for providing an item collection event according to an exemplary embodiment of the present invention includes: a slot selection input receiver transmitting an item collection screen including a slot for at least one collection and displaying each collection existence of at least one item to be collected and receiving a selection input from the user terminal for any one slot among the slots for at least one collection according to an item collection event as an event providing a reward according to the collection of the item when collecting at least one predetermined item; a slot item usage controller transmitting a slot item usage menu as a menu to receive usage input of a slot item as an item to be used in an arbitrary slot to the user terminal when receiving a selection input and determining the item corresponding to any one selectively input slot by using the slot item to be collected when receiving the selection input for the slot item usage menu; and a reward item providing unit transmitting a collection reward menu as a menu input to provide at least one predetermined item for input according to the collection of the item to the user terminal on a portion of the item collection screen and providing at least one predetermined item to a database of the item possessed by the user when receiving the selection input from the user terminal for the collection reward menu.

The slot item usage controller may transmit information informing that the usage of the slot item has failed when the number of slots using the slot item exceeds a predetermined threshold value among the slot for at least one collection included the item collection screen.

The reward item providing unit may provide the different items depending on a ratio of a sum of the number of slots determined by the collected item through the possession item of the user and the number of slots determined by the collected item by using the slot item for the number of all slots included in the item collection screen.

The reward item providing unit may provide at least one predetermined item after deleting the item corresponding to the slot determined by the collected item when providing the item from the database of the item possessed by the user.

The reward item providing unit may delete the item corresponding to the slot except for the slot determined by the collected item by using the slot item among the slot determined by the collected item.

### DETAILED DESCRIPTION OF THE EMBODIMENTS

Hereinafter, a method for providing an item collection event and a server according to an exemplary embodiment of the present invention will be described with reference to accompanying drawings.

In the following description, in order to clearly understand the present invention, description of a known technology regarding a characteristic of the present invention will be omitted. It is obvious that the following exemplary embodiment is a detailed description which is provided for better understanding of the present invention, and does not limit the scope of the present invention. Therefore, an equivalent invention which performs the same function as the present invention may also be covered by the scope of the present invention.

In the following description, like reference numerals designate like elements having the same configuration, and redundant description and description of a known technology will be omitted.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer that users access to use game contents. In the case of a game which has a small capacity or a small number of users, a plurality of game programs may be operated by one game server. Further, in the case of a game which has a large capacity or a large number of real time accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game on the game. The online game also indicates a game in which a user can buy various kinds of items in the game to play the game more smoothly.

Herein, an item indicates all data that can give assistance when playing the game and can be generally understood as an item on the game. For example, in a role playing game, an item for further increasing an experience level obtained when a character of a user subdues a monster, an item for changing the appearance of the character, and the like may correspond to the items in the present invention. Also, a mounting item improving the play of the game through an ability value improvement when playing the game by registering a character to a certain slot may also be included in the item.

In addition, in a sports game, a card item for using a character, an item for increasing a capability level of the character, an item for recovering a condition of the character, an item for increasing a capability level in the game and for simultaneously changing the appearance of the character by mounting the card to the character, and the like pertain to the items in the present invention. As such, all items that can be used by a character during the play of a game or that can be used by a user to apply it to the game pertain to the items in the present invention.

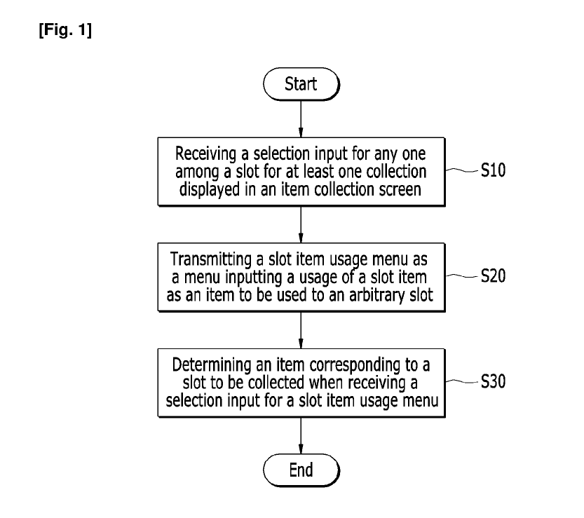

FIG. 1 is a flowchart of a method for providing an item collection event according to an exemplary embodiment of the present invention.

Referring to FIG. 1, in a method for providing an item collection event according to an exemplary embodiment of the present invention, firstly, after an event providing server transmits an item collection screen including a collect slot in which each collection existence of at least one item to be collected according to an item collection event is displayed to a user terminal, the event providing server performs a step of receiving a selection input from the user terminal for any one slot among the collect slot S10.

In the present invention, the item collection event means an event of collecting predetermined items among the items capable of being used in the described game and providing a reward for the collection. For example, when obtaining certain items among an equipment item mounted with a character through the user, it is displayed that the item is collected, and if it is determined that more items than a predetermined number are collected, the reward according thereto may be provided.

According to execution of the item collection event, the item collection screen displaying whether any item is connected may be displayed at a portion of the user terminal. A region displaying whether the item is collected is expressed as a slot.

In each slot, identification information such as a name of the item corresponding to the slot is displayed, and displaying the slot as filled is a display method to determine the item obtained and collected by the user. Accordingly, if the user executes an operation for registering the item to a database of the item owned by the user, for example, an operation for storing the item to an inventory or obtaining the item, it is determined that the item is collected.

After the step S10, if a selection input for any one slot is received, the server transmits a slot item usage menu as a menu capable of being input to use a slot item as an item to be used to an arbitrary slot to the corresponding slot to the user terminal S20.

The slot item usage menu may be displayed as a ring menu or a pop-up menu adjacent to the corresponding slot when receiving the selection input for one slot. The slot item may be used in any slot, and accordingly, the user selects one slot to be used as the slot item in the step S10 to execute the selection input for one slot.

If the user that confirms that the slot item usage menu is output by the step S20 selects the slot item usage menu, the server uses the slot item by corresponding to the selection input of the slot item usage menu. If the slot item is used, although the item corresponding to the slot is not presented in the item database owned by the user, it is determined to be collected S30.

That is, the slot item means an item capable of obtaining the effect like the collection of the item, but it is difficult to collect the item. Accordingly, when a high level item or the item that is difficult to collect are displayed in the item collection screen and then the items must be collected, the user may obtain the same result as easily collecting the item by using the slot item.

In the step S10, when transmitting the item collection screen to the user terminal while collecting the item, the server may transmit the item collection screen to divide and display the slot in which it is determined that the item is collected and the slot in which it is determined that the item is non-collected. In detail, among the slot that is determined by the collected item, the slot determined by the collected item since the user actually owns the corresponding item and the slot determined by the collected item by using the slot item may also be divided.

For example, the slot determined by the collected item since the user actually owns the corresponding item may be displayed by an image in which a certain color fills an empty image, the non-collected slot may be displayed by the empty image, and the slot using the slot item may be displayed by a shape in which the image of the slot item covers the empty image. The user may easily determine what the item collected by the user is and where the slot item is applied through only the confirmation of the item collection screen.

Also, in the present invention, in the slot using the slot item, deregistration of the slot item is impossible. For the effective execution of the event, the slot item is not deregistered by the user such that a thrill may be felt during the event.

Of course, the user does not include the collection item if the collection item does not exist at the database of the item owned by the user, and information informing that the usage of the collection item has failed may be displayed at the user terminal.

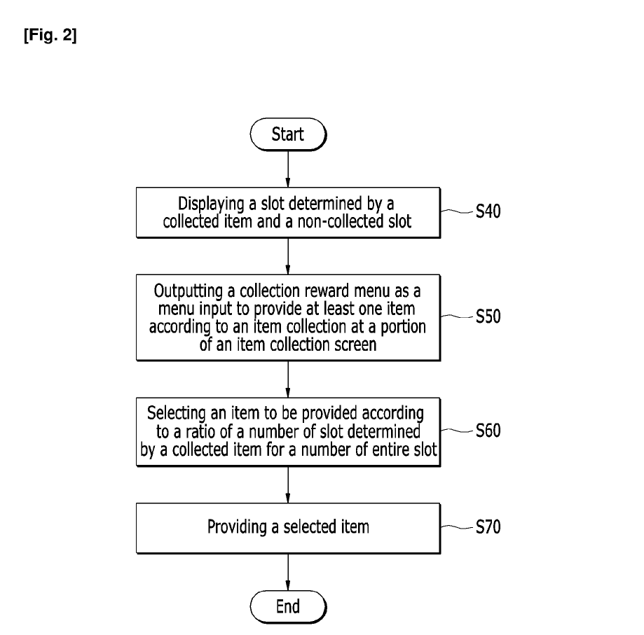

FIG. 2 is a flowchart providing a reward item according to a realization of an exemplary embodiment of the present invention. In the following description, the description of the portion overlapping the description for FIG. 1 will be omitted.

Referring to FIG. 2, firstly, as described above, on the item collection screen, the step S40 of dividing and displaying the slot determined by the item and the slot determined by the non-collected item is executed. That is, this step means the same flow as the step S10 of FIG. 1.

At this time, in the server, at the portion of the item collection screen, as a menu input to randomly provide a portion of at least one predetermined item according to the collection of the item, the collection reward menu is transmitted to the user terminal S50.

The collection reward menu starts to be displayed at the item collection screen from a time when the number of slots determined by the collected item becomes a certain number such that the item may be provided, or may be displayed to be fixed every time the item collection screen is displayed. In the former case, the user may confirm that the item may be provided to the user according to the collection event when confirming the collection reward menu. In the latter case, the user may confirm a guide message if the number of slots is not the number at which the item is provided when clicking the collection reward menu.

If the selection input for the collection reward menu is transmitted from the user terminal, the server randomly selects at least one predetermined item from the database of the item possessed by the user S60. In detail, the server may be set to provide the other item according to a ratio of the number of slots determined by the collected item for the number of all slots.

In the item collection event provided in the present invention, the number of items to be collected when the user executes the event, and the item, are assigned. For example, in a case of the event collecting 9 different items, the user may receive the reward according to the event when the user collects all of the 9 certain items.

In the present invention, additionally, when collecting more items than the predetermined amount, the reward item may be provided even if the value is lower compared with the case of collecting all items such that various rewards may be provided according to the event execution, thereby increasing the interest of the event execution of the user.

Accordingly, in the step S60, while at least one item is randomly provided according to the collection of the item, the item provides the different item according to the collection ratio. Also, a lowest limitation of the collection ratio may be set to only provide the item when the collection ratio of the item is more than a predetermined ratio (e.g., 60%).

Further, when the item is provided from the collection of more than 6 items among the 9 items, in each case of the collections of 6 items, 7 items, 8 items, and 9 items, the item to be provided may be set to be respectively different. That is, the item to be won on the 6-collection and the item to be won on the 8-collection may be set to be different, and at least one item of the predetermined items may be won.

In this case, the collection ratio of the item means a ratio of the number of slots determined by the collected item in all slots. The slot determined by the collected item includes the slot determined by the collected item by the item possessed by the user and the collected item by using the slot item.

If the user selects the item to be provided to the user by the step S60, the server executes the step S70 of registering the selected item to the database of the item included for the user to provide the item.

FIG. 3 is a flowchart when providing a reward item according to a realization of an exemplary embodiment of the present invention.

Referring to FIG. 3, the selected item is provided to the user by the step S70 through the flow of FIG. 2.

If the item is provided by the step S70, it is determined that the item collected by the user is consumed such that the server executes the step deleting the item corresponding to the slot from the database of the item of the user. At this time, the server deletes the item corresponding to the rest of the slots except for the slot using the slot item among the slot determined by the collected item S80.

The slot item may also be used for the slot corresponding to the item collected by the user. In this time, if the slot item is used for the slot determined by the collection by possessing the item by the user, a priority is determined for the slot item to be used instead of the item, and accordingly the item corresponding to the slot is maintained. Therefore, although the user uses the slot item, the item corresponding to the corresponding slot may be prevented from being deleted.

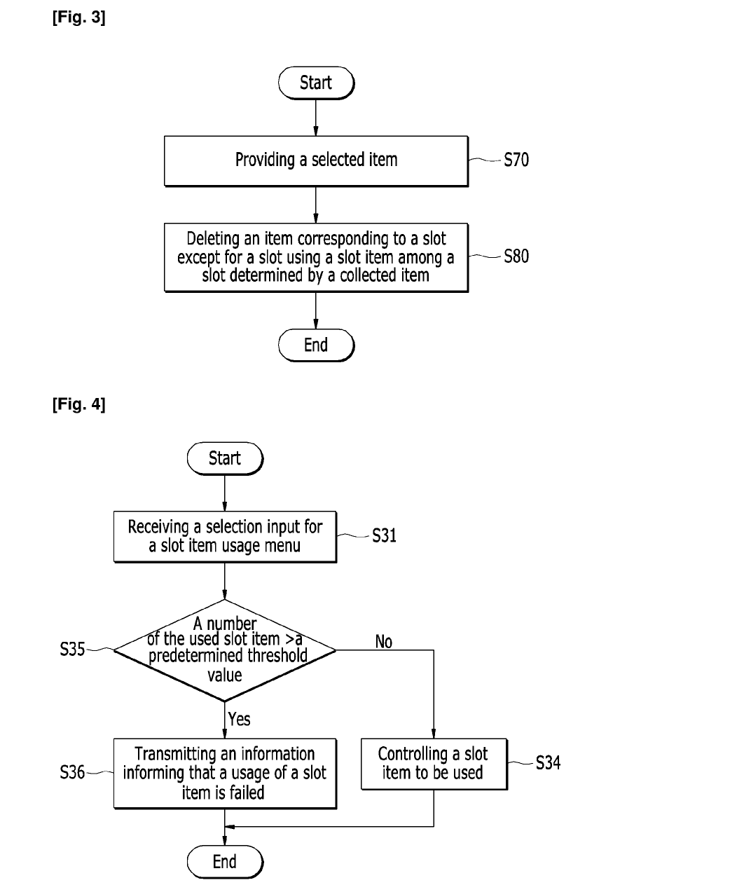

FIG. 4 is a flowchart of controlling usage of a slot item according to a realization of an exemplary embodiment of the present invention. Hereafter, the description of the portion overlapping that of FIGS. 1 to 3 is omitted.

Referring to FIG. 4, firstly, the server receives the selection input for the slot item usage menu from the user terminal S31.

At this time, the server determines the number of slots used for the slot item among the slots for the collection to determine whether the number of slots in which the slot item is used exceeds a predetermined threshold value (e.g., 3) S35.

In this case, if the number of slots in which the slot item is used does not exceed the predetermined threshold value, control to use the slot item is executed S34, however, in the case of exceeding the threshold value, a step of transmitting the information informing that the usage of the slot item has failed to the user terminal is executed S36.

If the usage upper limitation of the slot item is not determined, the user indiscriminately uses the slot item, and accordingly, an object of the item collection event may be diluted. Accordingly, in the present invention, the number of slot items to be used is limited.

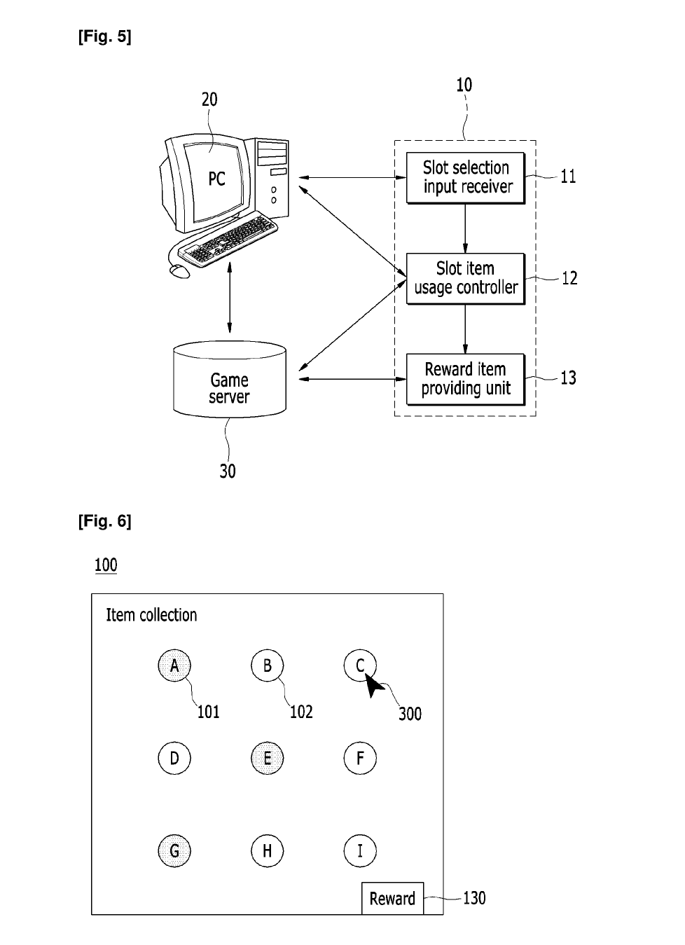

FIG. 5 is a schematic diagram of a server for providing an item collection event according to an exemplary embodiment of the present invention. In the following, the description of the portion overlapping the description for FIG. 1 to FIG. 4 will be omitted.

Referring to FIG. 5, a server 10 for providing an item collection event according to an exemplary embodiment of the present invention includes a slot selection input receiver 11, a slot item usage controller 12, and a reward item providing unit 13.

The slot selection input receiver 11 executes a function of receiving the selection input for any one slot among the slots for the collection from a user terminal 20, as well as transmitting the described item collection screen to the user terminal 20. The slot selection input receiver 11 transmits the identification information of the slot of the selection input to the slot item usage controller 12, when receiving the selection input.

When transmitting the item collection screen, the slot selection input receiver 11 may transmit it to divide and display the slot determined by the collected item and the slot determined by the non-collected item, in detail, to divide and display the slot determined to be collected by the possession of the user and the slot determined to be collected by the collection of the slot item.

The slot item usage controller 12 executes a function of transmitting the slot item usage menu using the slot item to the user terminal 20 when receiving the selection input for the slot, and a function of determining the item corresponding to the slot to be collected when receiving the selection input for the slot item.

Of course, the slot item usage controller 12 may transmit the information informing that the usage of the slot item has failed to the user terminal 20 when the user does not possess the slot item, or the slot item used by the user exceeds the predetermined threshold value.

The reward item providing unit 13 executes a function of transmitting the collection reward menu described at the portion of the item collection screen to the user terminal 20 and a function of providing at least one predetermined item to the database of the item possessed by the user when receiving the selection input for the collection reward menu from the user terminal 20.

In this case, the reward item providing unit may provide the different items according to the ratio of the slot determined by the collected item to the number of all slots, and deletes the item corresponding to the slot determined by the collected item while the item is provided. At this time, the corresponding item in the case of the sloth using the item is not deleted.

FIGS. 6 to 13 show examples of an event screen displayed to a user terminal according to realization of an exemplary embodiment of the present invention. In the following description, the description of the portion overlapping the description for FIG. 1 to FIG. 5 will be omitted.

Firstly, FIG. 6 shows an item collection screen 100. In the item collection screen, each of slots 101 and 102 is displayed. If each slot is confirmed, the slot 101 determined by the collected item by possessing the item by the user and the slot 102 determined by the non-collected item are divided and displayed. The user may select any one slot by moving an instrument means 300. A reward menu 103 is the described collection reward menu.

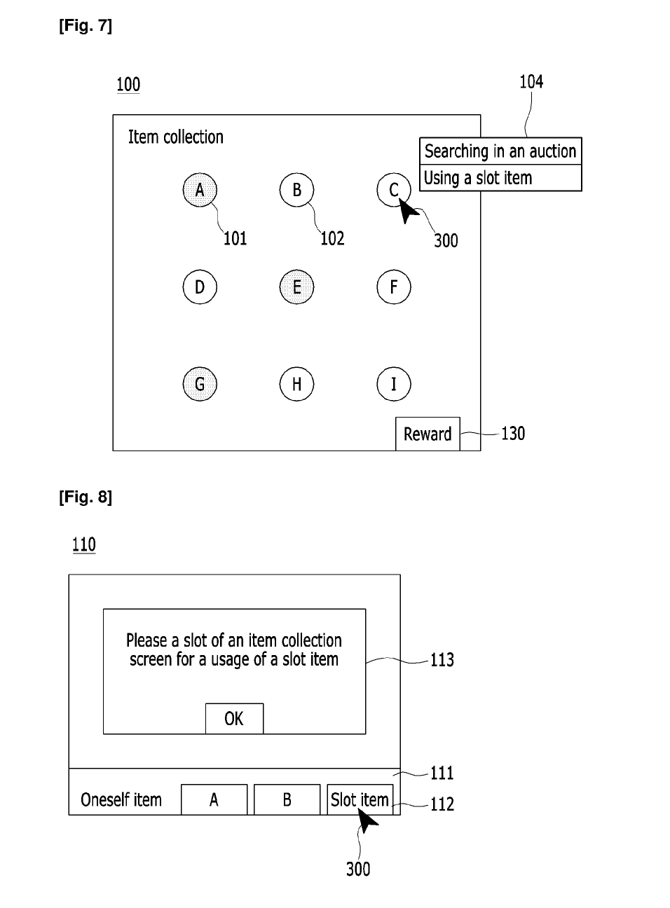

Referring to FIG. 7, for any one slot among a plurality of slots displayed at the item collection screen 100, it may be confirmed that the instrument means 300 is selected and the slot item usage menu 104 is displayed.

The user confirms a slot item usage menu 104 is displayed when selecting the slot, thereby using an auction service or the slot item to directly possess the item.

Referring to FIG. 8, in a game screen 110, within an inventory screen 111 that is capable of confirming the item possessed by the user, when clicking a slot item 112 by using the instrument means 300, a displayed guiding screen 113 may be confirmed.

For example, when using the slot item 112 in the inventory screen 111, the user may click to confirm the guiding message “please click the slot of the item collection screen for the usage of the slot item”, and accordingly, in the case of the slot item, and it may be confirmed that the slot must be selected to be used.

In FIG. 9, when selecting the slot item usage menu in the item collection screen 100, a menu 120 confirming whether the slot item is used is displayed. The user may confirm the slot to use the slot item, and selects an OK menu 121 to use the slot item for the corresponding slot or a cancel menu 122 to cancel the usage of the slot item.

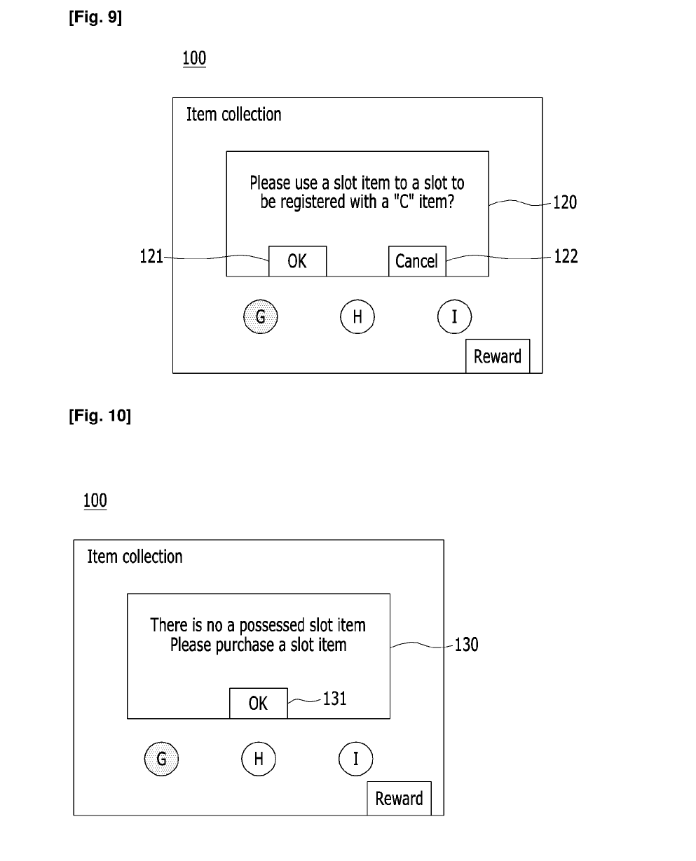

In FIG. 10, in the item collection screen 100, a slot item usage failure screen 130 is displayed when selecting the slot item usage menu. When the user does not possess the slot item, the user confirms the failure screen 130 and selects an OK menu 131, thereby purchasing the slot item or canceling the usage of the slot item. The screen 130 may be output when selecting the OK menu 121 in the screen 120 or before the output of the screen 120.

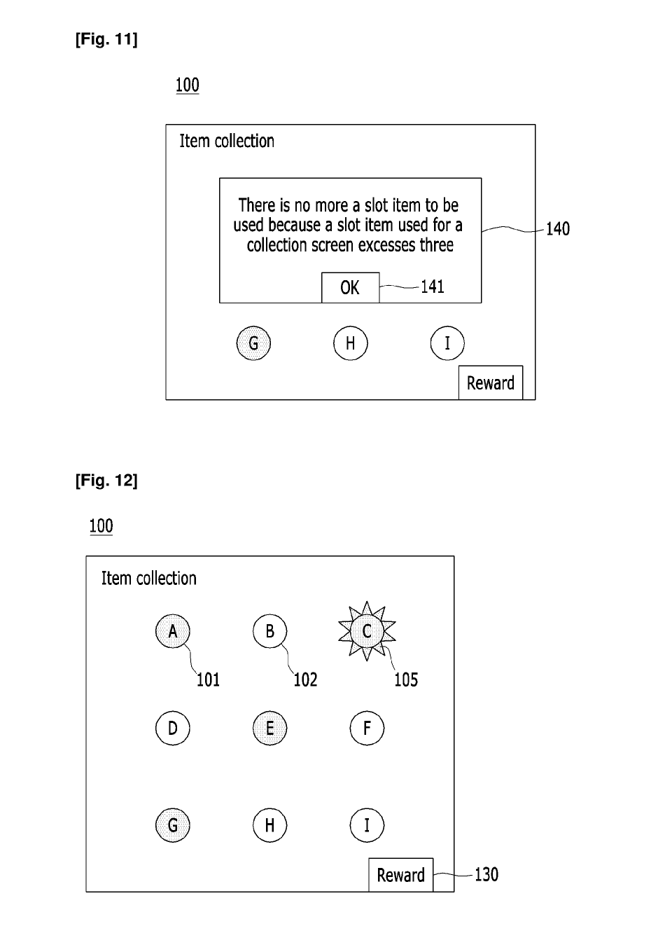

In FIG. 11, in the item collection screen 100, a screen 140 that in which the used slot item exceeds the predetermined threshold value such that the usage of the slot item has failed may be confirmed. Therefore, the user may confirm a method in which the user must directly collect the item for filling the corresponding slot since the user uses the slot item more than the predetermined threshold value (e.g., 3). The user may close the screen 140 by selecting an OK menu 141. The screen 140 may be output when selecting the OK menu 121 in the screen 120 or before the screen 120.

FIG. 12 shows the item collection screen 100, and in this case, it may be confirmed that a plurality of slots are divided and displayed. Firstly, the slot 101 in which the user possesses the item such that the item is collected is displayed. On the other hand, the slot 102 in which the item is non-collected is also displayed, and as the usage result of the slot item, a slot 105 determined by the collected item is displayed.

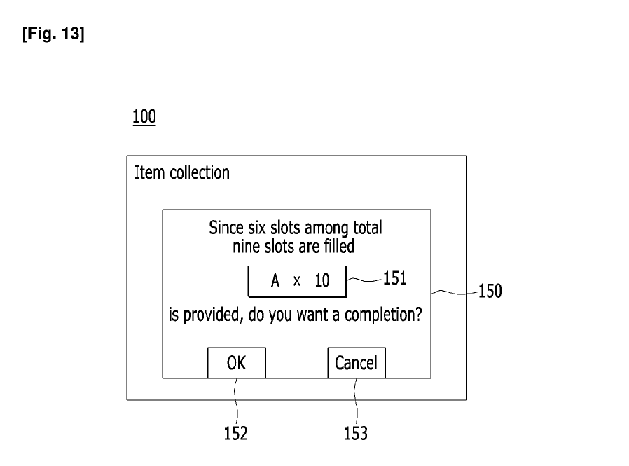

In FIG. 13, a reward screen 150 displayed when selecting the collection reward menu displayed in the item collection screen 100 is displayed.

The user, in the reward screen 150, may confirm whether the number of slots (e.g., 6) are filled among the number of (e.g., 9) all slots, thereby confirming information 151 of the provided item.

In this case, the user selects an OK menu 152 to receive the reward item, or selects a cancel menu 153 to collect the remaining item.

The method for providing the item collection event according to an exemplary embodiment of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or a web server associated with the applications or the corresponding services. The method for the providing the item collection event according to an exemplary embodiment of the present invention as described above may be implemented by the applications (i.e., programs) which are basically installed or directly installed by the user in the terminal, and may be recorded in a computer readable recording medium of the terminal and the like.

The programs are recorded in the computer readable recording medium and are executed by the computer, such that the above-mentioned functions may be executed.

As described above, in order for the computer to read the programs recorded in the recording medium and execute the method for the providing the item collection event according to an exemplary embodiment of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required for the processor of the computer to execute the above-mentioned functions according to a predetermined procedure.

Further, the code may include a memory reference related code indicating at which location (address number) of the memory inside or outside the computer additional information or media required for the processor of the computer to execute the above-mentioned functions needs to be referenced.

In addition, in order for the processor of the computer to execute the above-mentioned functions, when the processor needs to communicate with any other computers or servers, etc. at a remote location, the code may further include a communication related code regarding how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the method for providing the item collection event in accordance with the exemplary embodiments of the present invention, may be a storage medium (for example, a hard disk and the like) included in an application store server or an application providing server such as a web server associated with applications or corresponding services, and the like, or the application providing server itself.

A computer, which may read a recording medium recorded with applications that are programs for executing the method for providing the item collection event in accordance with the exemplary embodiments of the present invention, may include not only a general PC such as a typical desktop and a laptop, but also a mobile terminal such as a smart phone, a tablet PC, a personal digital assistant (PDA), and a mobile communication terminal, and is to be construed as all the computable devices.

When a computer, which may read a recording medium recorded with applications that are programs for executing the method for providing the item collection event in accordance with the exemplary embodiments of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more components without departing from the scope of the present invention. In addition, although each of all the components may be implemented by one piece of independent hardware, some or all of the respective components which are selectively combined with each other may be implemented by a computer program having a program module performing some or all of functions combined with each other in one or multiple pieces of hardware. The codes and the code segments configuring the computer program may be easily inferred by a person having ordinary skill in the art to which the present invention pertains. The computer programs are stored in the computer readable media and are read and executed by the computer, and may implement the exemplary embodiment of the present invention. As the storage medium of the computer programs, a magnetic recording medium, an optical recording medium, and the like may be used.

Further, it will be understood that the terms “comprises” or “have” used in this specification may include the corresponding components unless explicitly described to the contrary, and therefore do not preclude other components but further include the components. In addition, unless defined otherwise in the detailed description, all the terms including technical and scientific terms have the same meaning as those generally understood by those skilled in the art to which the present invention pertains. Generally used terms such as terms defined in a dictionary should be interpreted as having the same meanings as those within a context of the related art, and should not be interpreted as ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted that all spirits equivalent to the following claims fall within the scope of the present invention.

1. A method for providing an item collection event through an event providing server comprising:
transmitting an item collection screen including at least one slot for collection in which each collection of at least one item to be collected is displayed to a user terminal according to an item collection event as an event providing a reward according to a collection of the item when collecting at least one predetermined item;
receiving a selection input for any one slot among at least one slot for the collection from the user terminal;
transmitting a slot item usage menu as a menu to receive a usage input of a slot item as an item to be used in an arbitrary slot to the user terminal when receiving the selection input; and
determining the item corresponding to any one slot selectively input by using the slot item to be collected when receiving the selection input for the slot item usage menu.

2. The method of claim 1, wherein,
in the determining step,
information informing that the usage of the slot item has failed is transmitted when a number of slots using the slot item exceeds a predetermined threshold value among at least one slot for the collection included in the item collection screen.

3. The method of claim 1, wherein
in the transmitting of the item collection screen to the user terminal,
the item collection screen in which the slot determined by the collected item through the item possession of the user, the slot determined by the non-collected item, and the slot determined by the collected item by using the slot item are displayed to be different is transmitted to the user terminal.

4. The method of claim 1, further comprising
transmitting a collection reward menu as a menu input to provide at least one predetermined item according to the collection of the item at a portion of the item collection screen to the user terminal.

5. The method of claim 4, further comprising:
providing at least one predetermined item to the database of the item possessed to the user when receiving the selection input from the user terminal for the collection reward menu.

6. The method of claim 5, wherein,
in the providing of the item,
The different items are provided depending on a ratio of a sum of the number of slots determined by the collected item through the possessed item of the user and the number of slots determined by the collected item by using the slot item for the number of all slots included in the item collection screen.

7. The method of claim 5, wherein,
in the providing of the item,
the item corresponding to the slot except for the slot determined by the collected item by using the slot item is deleted among the slot determined by the collected item.

8. The method of claim 7, wherein,
in the providing of the item,
when the user possesses the item corresponding to the slot determined by the collected item and the slot determined by the usage of the slot item exists in the slot determined by the collected item, the item corresponding to the existed slot is maintained and at least one predetermined item is provided.

9. The method of claim 1, wherein,
in the determining,
when receiving the selection input for the slot item usage menu, when the slot item does not exist in the database of the item possessed by the user, the information informing that the usage of the slot item has failed is transmitted to the user terminal.

10. A server for providing an item collection event, comprising:
a slot selection input receiver transmitting an item collection screen including a slot for at least one collection and displaying each collection existence of at least one item to be collected and receiving a selection input from the user terminal for any one slot among the slots for at least one collection according to an item collection event as an event providing a reward according to the collection of the item when collecting at least one predetermined item;
a slot item usage controller transmitting a slot item usage menu as a menu to receive usage input of a slot item as an item to be used in an arbitrary slot to the user terminal when receiving a selection input and determining the item corresponding to any one selectively input slot by using the slot item to be collected when receiving the selection input for the slot item usage menu; and
a reward item providing unit transmitting a collection reward menu as a menu input to provide at least one predetermined item for input according to the collection of the item to the user terminal on a portion of the item collection screen and providing at least one predetermined item to a database of the item possessed by the user when receiving the selection input from the user terminal for the collection reward menu.

11. The server of claim 10, wherein:
the slot item usage controller may transmit information informing that the usage of the slot item has failed when the number of slots using the slot item exceeds a predetermined threshold value among the slot for at least one collection included the item collection screen.

12. The server of claim 10, wherein
reward item providing unit may provide the different items depending on a ratio of a sum of the number of slots determined by the collected item through the possession item of the user and the number of slots determined by the collected item by using the slot item for the number of all slots included in the item collection screen.

13. The server of claim 10, wherein
the reward item providing unit provides at least one predetermined item after deleting the item corresponding to the slot determined by the collected item when providing the item from the database of the item possessed by the user.

14. The server of claim 13, wherein
the reward item providing unit deletes the item corresponding to the slot except for the slot determined by the collected item by using the slot item among the slot determined by the collected item.

15. A computer readable recording medium recorded with a program for executing a method for providing an item collection event through an event providing server,
wherein the method includes:
transmitting an item collection screen including at least one slot for collection in which each collection of at least one item to be collected is displayed to a user terminal according to an item collection event as an event providing a reward according to a collection of the item when collecting at least one predetermined item;
receiving a selection input for any one slot among at least one slot for the collection from the user terminal;
transmitting a slot item usage menu as a menu to receive a usage input of a slot item as an item to be used in an arbitrary slot to the user terminal when receiving the selection input; and
determining the item corresponding to any one slot selectively input by using the slot item to be collected when receiving the selection input for the slot item usage menu.
